(19) United States
(12) Patent Application Publication
(10) Pub. No.: US 2026/0140086 A1
(43) Pub. Date: May 21, 2026

(54) DETECTION DEVICE

(71) Applicant: InnoLux Corporation, Miao-Li County (TW)

(72) Inventors: Chia-Chun LIU, Miao-Li County (TW); Hao-Jung HUANG, Miao-Li County (TW); Kuang-Pin CHAO, Miao-Li County (TW)

(21) Appl. No.: 19/359,167

(22) Filed: Oct. 15, 2025

Related U.S. Application Data
(60) Provisional application No. 63/720,964, filed on Nov. 15, 2024.

(30) Foreign Application Priority Data
Aug. 13, 2025 (CN) 202511131082.8

(51) Int. Cl. G01N 27/416

(52) U.S. Cl. CPC G01N 27/416

(57) ABSTRACT

A detection device includes: a substrate assembly; a cover assembly disposed on the substrate assembly, wherein the substrate assembly and the cover assembly together form a first cavity and a second cavity; a first electrode disposed in the first cavity; a second electrode disposed in the second cavity; a connecting pipe connecting the first cavity and the second cavity; an inflow pipe connecting the first cavity or the second cavity; and an outflow pipe connecting the first cavity or the second cavity.

### CROSS-REFERENCE TO RELATED APPLICATIONS

This application claims the benefits of the Chinese Patent Application Serial Number 202511131082.8, filed on Aug. 13, 2025, the subject matter of which is incorporated herein by reference.

This application claims the benefit of filing date of U.S. Provisional Application Ser. No. 63/720,964, filed Nov. 15, 2024 under 35 USC § 119(e)(1).

### BACKGROUND

### Field

The present disclosure relates to a detection device and, more particularly relates to a detection device in which a first electrode and a second electrode are respectively disposed in a first cavity and a second cavity.

### Description of Related Art

Traditionally, a working electrode and a reference electrode in a solution detection device are placed in the same environment, and detection is performed through a loop formed by a test solution between the working electrode and the reference electrode. However, this design does not meet the appropriate operating conditions for each electrode. For example, the test solution in the working electrode's operating environment must be regularly emptied, while the reference electrode must be immersed in a liquid environment to provide a stable reference voltage. This can easily lead to reduced detection accuracy and shortened electrode life. In addition, if a single electrode is damaged, the entire detection device will be scrapped, increasing maintenance costs.

Therefore, it is desirable to provide a detection device to improve the aforesaid defects.

### SUMMARY

The present disclosure provides a detection device, comprising: a substrate assembly; a cover assembly disposed on the substrate assembly, wherein the substrate assembly and the cover assembly together form a first cavity and a second cavity; a first electrode disposed in the first cavity; a second electrode disposed in the second cavity; a connecting pipe connecting the first cavity and the second cavity; an inflow pipe connecting the first cavity and the second cavity; and an outflow pipe connecting the first cavity or the second cavity.

Other novel features of the disclosure will become more apparent from the following detailed description when taken in conjunction with the accompanying drawings.

### BRIEF DESCRIPTION OF DRAWINGS

FIG. 1A is a top schematic view of a part of a detection device according to one embodiment of the present disclosure.

FIG. 1B is a cross-sectional schematic view of the line A-A′ in FIG. 1A.

FIG. 1C and FIG. 1D respectively are partial enlarged schematic views of a detection device.

FIG. 2A is a top schematic view of a part of a detection device according to one embodiment of the present disclosure.

FIG. 2B is a cross-sectional schematic view of the line B-B′ of FIG. 2A.

FIG. 2C is a cross-sectional schematic view of a part of a detection device according to one embodiment of the present disclosure.

FIG. 3A is a top schematic view of a part of a detection device according to one embodiment of the present disclosure.

FIG. 3B is a top schematic view of a part of a detection device according to one embodiment of the present disclosure.

FIG. 4A is a top schematic view of a part of a detection device according to one embodiment of the present disclosure.

FIG. 4B is a cross-sectional schematic view of a line C-C′ of FIG. 4A.

FIG. 5A is a top schematic view of a part of a detection device according to one embodiment of the present disclosure.

FIG. 5B is a cross-sectional schematic view of a line D-D′ of FIG. 5A.

FIG. 5C is a partial enlarged schematic view of FIG. 5B.

FIG. 6A is a top schematic view of a part of a detection device according to one embodiment of the present disclosure.

FIG. 6B is a top schematic view of a part of a detection device according to one embodiment of the present disclosure.

FIG. 7 is a cross-sectional schematic view is a part of a detection device according to one embodiment of the present disclosure.

FIG. 8 is an operation schematic view according to one embodiment of the present disclosure.

FIG. 9 is a schematic view of a delivery module according to one embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

The embodiments of the present disclosure may be understood in conjunction with the drawings, which are also considered part of the disclosure. It should be understood that the drawings of the present disclosure are not drawn to scale, and in fact, the size of the elements may be arbitrarily enlarged or reduced in order to clearly show the features of the present disclosure. In addition, the directional terms mentioned in the present disclosure, such as “up”, “down”, “front”, “back”, “left”, “right”, etc., are only referenced to the directions of the accompanying drawings. Therefore, the directional terms used are for illustration and are not intended to limit the present disclosure. In the accompanying drawings, each diagram depicts the general characteristics of the methods, structures and/or materials used in a particular embodiment. However, these diagrams should not be interpreted as defining or limiting the scope or nature covered by these embodiments. For example, for the sake of clarity, the relative size, thickness and position of each layer, region and/or structure may be reduced or enlarged.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure. In the present disclosure, the term “relatively disposed” or “disposed relative to” refers to, for example, the elements substantially overlapping each other, but the present disclosure is not limited thereto.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the term “electrically connected” or “coupled” includes any direct and indirect electrical connection means.

In the present specification, the terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to some embodiments of the present disclosure, the thickness, the length, the width, the height or the distance and angle between elements may be measured by using an optical microscope (OM), scanning electron microscope (SEM), film thickness profiler (α-step), ellipsometer, or other suitable methods. More specifically, according to some embodiments, a scanning electron microscope can be used to obtain a cross-sectional image of the structure and measure the thickness, length, width, height of each element or the distance and angle between elements.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments can be replaced, combined or mixed with each other to form another embodiment without violating the spirit of the present disclosure.

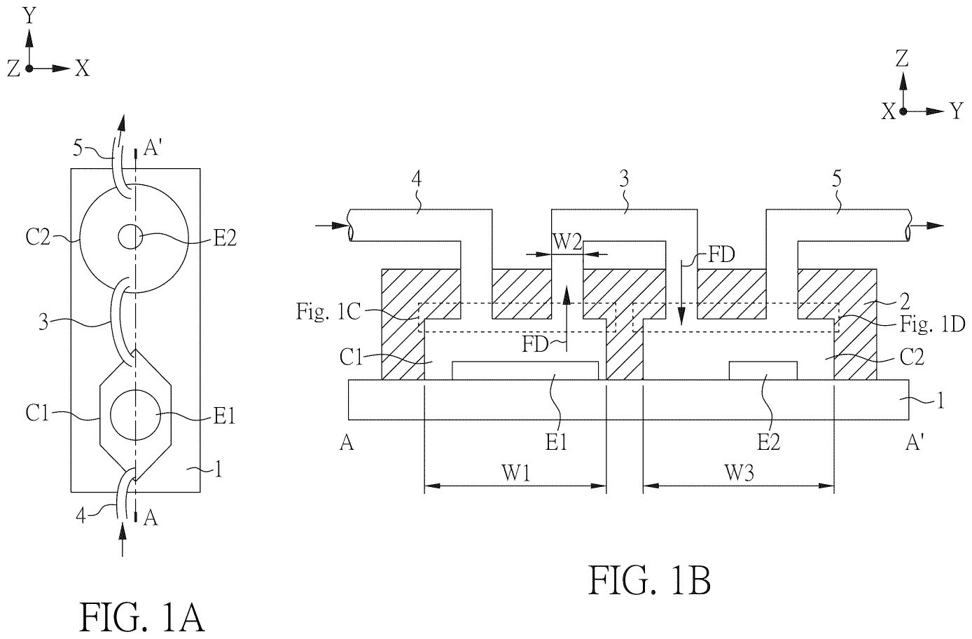

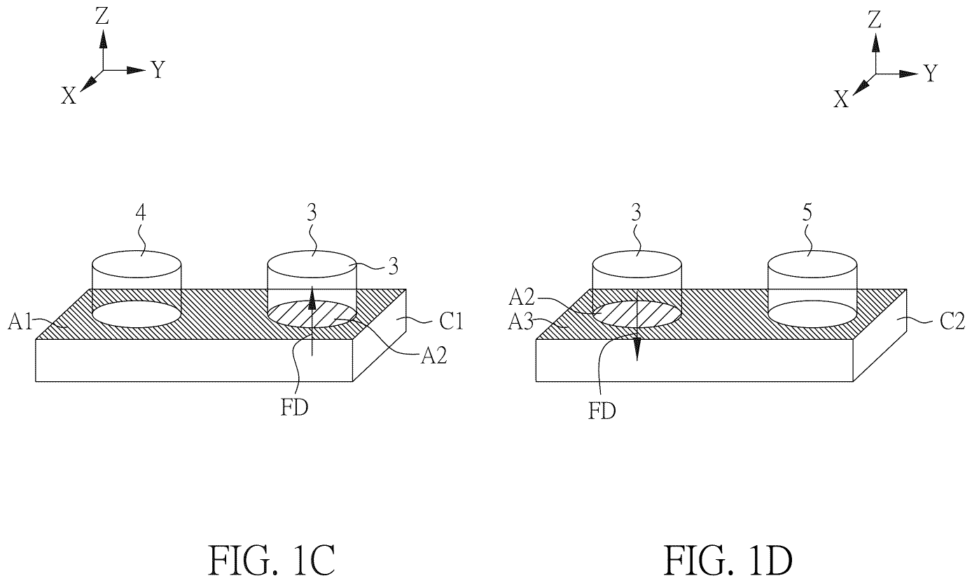

FIG. 1A is a top schematic view of a part of a detection device according to one embodiment of the present disclosure. FIG. 1B is a cross-sectional schematic view of the line A-A′ in FIG. 1A. FIG. 1C and FIG. 1D respectively are partial enlarged schematic views of a detection device. For the sake of convenience, the cover assembly 2 is omitted in FIG. 1A.

In one embodiment of the present disclosure, as shown in FIG. 1A and FIG. 1B, the detection device may comprise: a substrate assembly 1; a cover assembly 2 disposed on the substrate assembly 1, wherein the substrate assembly 1 and the cover assembly 2 together form a first cavity C1 and a second cavity C2; a first electrode E1 disposed in the first cavity C1; a second electrode E2 disposed in the second cavity C2; a connecting pipe 3 connecting the first cavity C1 and the second cavity C2; an inflow pipe 4 connecting the first cavity C1 or the second cavity C2; and an outflow pipe 5 connecting the first cavity C1 or the second cavity C2. For example, the inflow pipe 4 may connect the first cavity C1, and the outflow pipe 5 may connect the second cavity C2. Thus, the solution may flow from the inflow pipe 4 into the first cavity C1, flow through the connecting pipe 3 to the second cavity C2, and finally flow out through the outflow pipe 5. The solution forms a loop between the first electrode E1 and the second electrode E2, enabling solution detection.

In one embodiment of the present disclosure, as shown in FIG. 1B, in a cross section, in a direction perpendicular to the normal direction Z of the substrate assembly 1, that is, the Y direction, the first cavity C1 has a first width W1, the connecting pipe 3 has a second width W2, and the first width W1 is greater than the second width W2. In one embodiment of the present disclosure, as shown in FIG. 1B, in a cross section, in a direction perpendicular to the normal direction Z of the substrate assembly 1, that is, the Y direction, the second cavity C2 has a third width W3 and the third width W3 is greater than the second width W2. In one embodiment of the present disclosure, the widths of the first cavity C1/the second cavity C2/the connecting pipe 3 refers to, the minimum widths of the first cavity C1/the second cavity C2/the connecting pipe 3 in a direction perpendicular to the solution flow direction FD.

In one embodiment of the present disclosure, as shown in FIG. 1B and FIG. 1C, the first cavity C1 has a first cross-sectional area A1 and the connecting pipe 3 has a second cross-sectional area A2 perpendicular to the normal direction Z of the substrate assembly 1, wherein the first cross-sectional area A1 is greater than the second cross-sectional area A2. In one embodiment of the present disclosure, as shown in FIG. 1B and FIG. 1D, the second cavity C2 has a third cross-sectional area A3 perpendicular to the normal direction Z of the substrate assembly 1, and the third cross-sectional area A3 is greater than the second cross-sectional area A2. In one embodiment of the present disclosure, the cross-sectional areas of the first cavity C1/the second cavity C2/the connecting pipe 3 refers to, for example, the minimum cross-sectional areas of the first cavity C1/the second cavity C2/the connecting pipe 3 perpendicular to the solution flow direction FD.

In the present disclosure, the material of the substrate assembly 1 may comprise quartz, glass, silicon wafer, sapphire, polycarbonate (PC), polyimide (PI), polypropylene (PP), polyethylene terephthalate (PET), other plastic or polymer materials, other inorganic materials, or other organic materials or a combination thereof, but the present disclosure is not limited thereto. In the present disclosure, the material of the cover assembly 2 may comprise quartz, glass, polycarbonate (PC), polyimide (PI), polypropylene (PP), polyethylene terephthalate (PET), other plastic or polymer materials, other inorganic materials, other organic materials or a combination thereof, but the present disclosure is not limited thereto.

In the present disclosure, the sizes of the first cavity C1 and the second cavity C2 are not particularly limited. For example, in a top view, a projection area of the first cavity C1 on the substrate assembly 1 may be, for example, greater than, equal to or less than a projection area of the second cavity C2 on the substrate assembly 1. In one embodiment of the present disclosure, as shown in FIG. 1A, in a cross section, a projection area of the first cavity C1 on the substrate assembly 1 may be less than a projection area of the second cavity C2 on the substrate assembly 1, but the present disclosure is not limited thereto. In the present disclosure, the shapes of the first cavity C1 and the second cavity C2 are not particularly limited. For example, in a cross section, the first cavity C1 and the second cavity C2 may each be circular, oval, rectangular, prismatic, hexagonal, octagonal or other irregular shapes, but the present disclosure is not limited thereto. In one embodiment of the present disclosure, in a cross section, as shown in FIG. 1A, the first cavity C1 may be, for example, hexagonal, and the second cavity C2 may be, for example, circular.

In the present disclosure, the sizes of the first electrode E1 and the second electrode E2 are not particularly limited. For example, in a cross section, a projection area of the first electrode E1 on the substrate assembly 1 may be, for example, greater than, equal to or less than a projection area of the second electrode E2 on the substrate assembly 1. In one embodiment of the present disclosure, as shown in FIG. 1A, in a cross section, the projection area of the first electrode E1 on the substrate assembly 1 may be greater than the projection area of the second electrode E2 on the substrate assembly 1, but the present disclosure is not limited thereto. In the present disclosure, the shapes of the first electrode E1 and the second electrode E2 are not particularly limited. For example, in a cross section, the first electrode E1 and the second electrode E2 may each be circular, oval, rectangular, prismatic, hexagonal, octagonal or other irregular shapes, but the present disclosure is not limited thereto. In one embodiment of the present disclosure, in a cross section, as shown in FIG. 1A, the first electrode E1 and the second electrode E2 may be, for example, circular.

In one embodiment of the present disclosure, the first electrode E1 may be, for example, a working electrode, and the second electrode E2 may be, for example, a reference electrode, but the present disclosure is not limited thereto. In other embodiments, the first electrode E1 may be a reference electrode, and the second electrode E2 may be a working electrode. The working electrode may comprise a metal material and a sensing material. Suitable metal material may comprise, for example, gold, silver, copper, aluminum, titanium, chromium, nickel, molybdenum or a combination thereof, but the present disclosure is not limited thereto. Suitable sensing material may be, for example, a metal oxide such as indium tin oxide (ITO), zinc dioxide, tin dioxide, indium zinc oxide (IZO), indium tin zinc oxide (ITZO), indium gallium zinc oxide (IGZO), aluminum zinc oxide (AZO), ruthenium oxide (RuO₂; RuO₄) or a combination thereof, but the present disclosure is not limited thereto. The reference electrode may comprise silver chloride. In one embodiment of the present disclosure, the detection device may be, for example, a pH detection device used for detecting the pH value of a test solution. When the working electrode is affected by the pH value of the test solution, that is, when the solution has different hydrogen ion concentrations, the working electrode can have different induced voltage changes, thereby detecting the pH value of different test solutions. In one embodiment of the present disclosure, the surface of the working electrode can be modified as needed to make it suitable for other detection applications. For example, the surface of the working electrode can be modified with gold nanoparticles, allowing the working electrode to serve as a glucose sensing electrode, enabling the detection device to be applied to glucose detection. In another embodiment of the present disclosure, even not shown in the figure, multiple working electrodes can be placed in the first cavity C1 to simultaneously detect different properties of the test solution, thereby saving detection time and improving detection efficiency.

In the present disclosure, the connecting pipe 3, the inflow pipe 4 and the outflow pipe 5 is a channel that allows the solution to pass through. The materials of the connecting pipe 3, the inflow pipe 4 and the outflow pipe 5 may respectively comprise quartz, glass, polycarbonate (PC), polyimide (PI), polypropylene (PP), polyethylene terephthalate (PET), resin, rubber, other plastic or polymer materials, other inorganic materials, other organic materials or a combination thereof, but the present disclosure is not limited thereto.

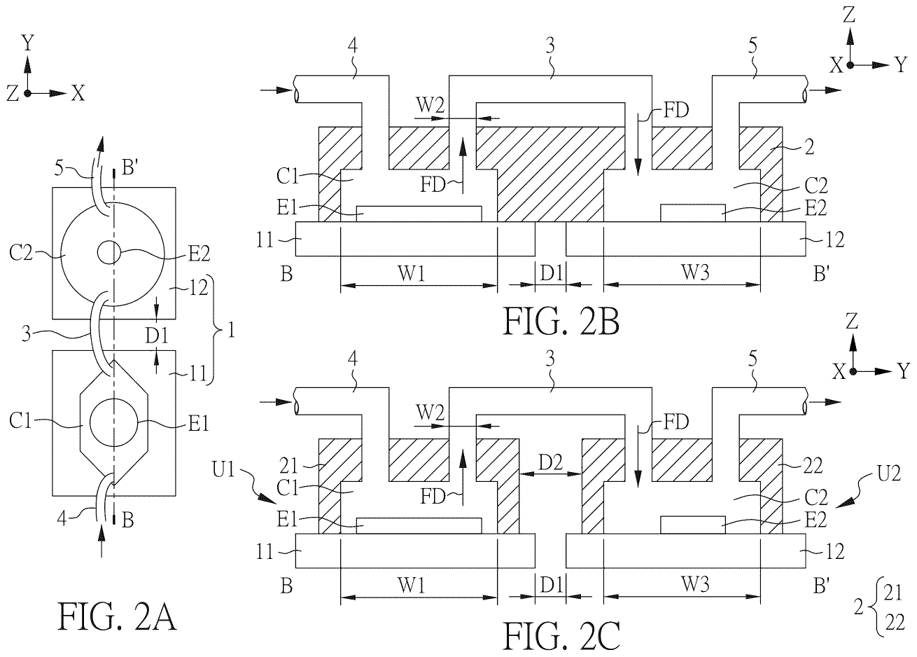

FIG. 2A is a top schematic view of a part of a detection device according to one embodiment of the present disclosure. FIG. 2B is a cross-sectional schematic view of the line B-B′ of FIG. 2A. The detection device of FIG. 2A is similar to that of FIG. 1A, except for the following differences. In addition, for the sake of convenience, the cover assembly 2 is omitted in FIG. 2A.

In one embodiment of the present disclosure, as shown in FIG. 2A and FIG. 2B, the substrate assembly 1 may comprise a first sub-substrate 11 and a second sub-substrate 12, and the first sub-substrate 11 is separated from the second sub-substrate 12 by a distance D1. The first sub-substrate 11 and the cover assembly 2 together form the first cavity C1, and the second sub-substrate 12 and the cover assembly 2 together form the second cavity C2. The inflow pipe 4 may connect the first cavity C1, and the outflow pipe 5 may connect the second cavity C2. In this way, the solution can flow from the inflow pipe 4 into the first cavity C1, flow through the connecting pipe 3 to the second cavity C2, and finally flow out through the outflow pipe 5. Through the aforesaid design, the first electrode E1 and the second electrode E2 may be disposed on different sub-substrates. That is, the first electrode E1 is disposed on the first sub-substrate 11, and the second electrode E2 is disposed on the second sub-substrate 12. Thus, when one of the first electrode E1 or the second electrode E2 is damaged, the first sub-substrate 11 or the second sub-substrate 12 can be replaced independently, thereby reducing maintenance costs.

In the present disclosure, other detail features of the detection device of FIG. 2A and FIG. 2B may be as those of FIG. 1A and FIG. 1B, which are not described again here.

FIG. 2C is a cross-sectional schematic view of a part of a detection device according to one embodiment of the present disclosure. The detection device of FIG. 2C is similar to that of FIG. 2B, except for the following differences.

In another embodiment of the present disclosure, since the detection device of FIG. 2C is similar to that of FIG. 2B, the top schematic view of the detection device of FIG. 2C may be referred to that of FIG. 2A. As shown in FIG. 2A and FIG. 2C, the cover assembly 2 may comprise a first portion 21 and a second portion 22, and the first portion 21 is separated from the second portion 22 by a distance D2. The first portion 21 and the substrate assembly 1 together form the first cavity C1, and the second portion 22 and the substrate assembly 1 together form the second cavity C2. More specifically, as shown in FIG. 2C, the first portion 21 of the cover assembly 2 and the first sub-substrate 11 together form the first cavity C1, and the second portion 22 of the cover assembly 2 and the second sub-substrate 12 together form the second cavity C2.

In the present disclosure, the first portion 21 of the cover assembly 2, the first sub-substrate 11 and the first electrode E1 may form a first unit U1, and the second portion 22 of the cover assembly 2, the second sub-substrate 12 and the second electrode E2 may form a second unit U2. With this design, if either the first electrode E1 or the second electrode E2 is damaged, either the first unit U1 or the second unit U2 can be replaced independently, thus reducing maintenance costs.

In the present disclosure, other detail features of the detection device of FIG. 2C may be as those of FIG. 2A and FIG. 2B, which are not described again here.

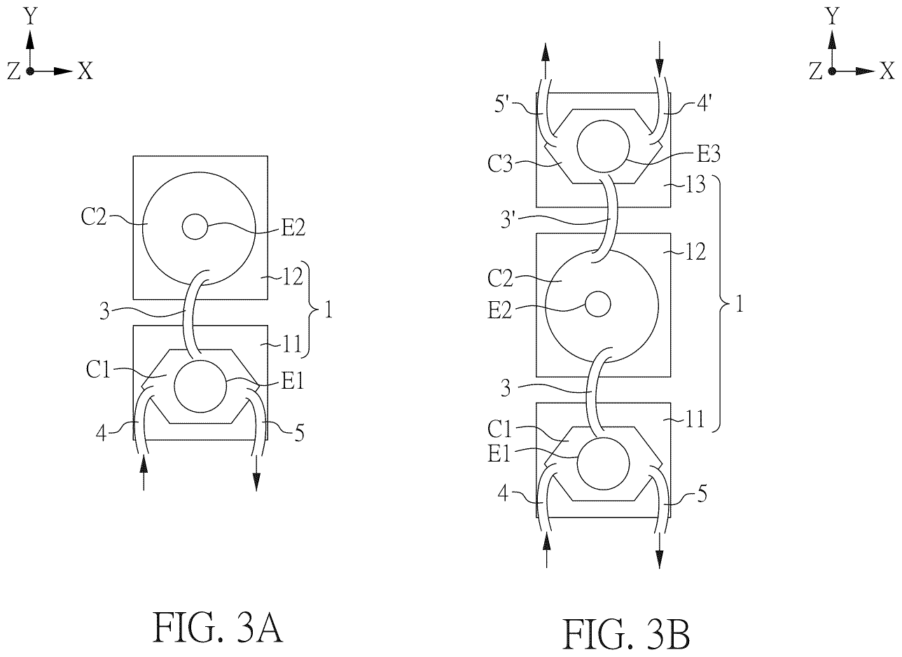

FIG. 3A is a top schematic view of a part of a detection device according to one embodiment of the present disclosure. The detection device of FIG. 3A is similar to that of FIG. 2A, except for the following differences. In addition, for the sake of convenience, the cover assembly 2 is omitted in FIG. 3A.

In one embodiment of the present disclosure, as shown in FIG. 3A, the inflow pipe 4 connects the first cavity C1 and the outflow pipe 5 connects the first cavity C1. Thus, by controlling the dimensions of the pipes (including the connecting pipe 3, the inflow pipe 4, and the outflow pipe 5) and/or applying external forces (such as a pressurized pump), the solution can flow from the inflow pipe 4 into the first cavity C1 and out through the outflow pipe 5. The solution then forms a loop between the first electrode E1 and the second electrode E2 through the connecting pipe 3, allowing for solution testing.

In one embodiment of the present disclosure, the second cavity C2 can be pre-filled with a standard solution, and the second electrode E2 can be immersed in the standard solution to provide a stable reference voltage. When performing solution testing, the test solution flows from the inflow pipe 4 into the first cavity C1. The test solution forms a loop between the first electrode E1 and the second electrode E2 via the connecting pipe 3, allowing the first electrode E1 to detect the test solution based on changes in induced voltage. Thus, the first electrode E1 (e.g., the working electrode) and the second electrode E2 (e.g., the reference electrode) can each be maintained in a suitable operating environment, thereby improving the accuracy of detection or extending the service life of the electrodes.

In the present disclosure, the cover assembly 2 of FIG. 3A may be referred to those of FIG. 2B and FIG. 2C. Thus, other detail features of the detection device of FIG. 3A may be as those of FIG. 2A to FIG. 2C, which are not described again here.

FIG. 3B is a top schematic view of a part of a detection device according to one embodiment of the present disclosure. The detection device of FIG. 3B is similar to those of FIG. 2A and FIG. 3A, except for the following differences. In addition, for the sake of convenience, the cover assembly 2 is omitted in FIG. 3B.

In one embodiment of the present disclosure, as shown in FIG. 3B, the substrate assembly 1 may further comprise a third sub-substrate 13, wherein the second sub-substrate 12 is disposed between the first sub-substrate 11 and the third sub-substrate 13. The third sub-substrate 13 and the cover assembly 2 (as shown in FIG. 2B) may together form a third cavity C3. In addition, the detection device may further comprise: a third electrode E3 disposed in the third cavity C3; another connecting pipe 3′ connecting the third cavity C3 and the second cavity C2; another inflow pipe 4′ connecting the third cavity C3; and another outflow pipe 5′ connecting the third cavity C3.

The test solution can flow into the first cavity C1 through the inflow pipe 4 and out through the outflow pipe 5. The test solution can form a loop between the first electrode E1 and the second electrode E2 through the connecting pipe 3 to test the test solution. Another test solution can flow into the third cavity C3 through another inflow pipe 4′ and out through another outflow pipe 5′. Another test solution can also form a loop between the third electrode E3 and the second electrode E2 through another connecting pipe 3′ to test another test solution. Thus, the first electrode E1 and the third electrode E3 can share the reference voltage provided by the second electrode E2, allowing testing different test solutions simultaneously, and improving detection efficiency. Since the first electrode E1, the second electrode E2, and the third electrode E3 are disposed on different sub-substrates, when one or more of the first electrode E1, the second electrode E2, and the third electrode E3 are damaged, the first sub-substrate 11, the second sub-substrate 12, and/or the third sub-substrate 13 containing the damaged electrodes can be replaced separately, thereby achieving the effect of reducing maintenance costs.

In the present disclosure, the connecting pipe 3′, the inflow pipe 4′ and the outflow pipe 5′ are channels that allow solution to pass through. The materials of the connecting pipe 3′, the inflow pipe 4′ and the outflow pipe 5′ may be as those of the connecting pipe 3, the inflow pipe 4 and the outflow pipe 5, which are not described again here. In the present disclosure, the cover assembly 2 of FIG. 3B may be referred to that of FIG. 2B, which is not described again here. In addition, the cover assembly 2 of FIG. 3B may also include the first portion 21, the second portion 22 and the third portion (not shown in the figure) as shown in FIG. 2C, wherein the third portion (not shown in the figure) and the third sub-substrate 13 may together form the third cavity C3. Since the first cavity C1, the second cavity C2 and the third cavity C3 are formed by different sub-substrates and different portions of the cover assembly 2, when one or more of the first electrode E1, the second electrode E2, and the third electrode E3 are damaged, the first sub-substrate 11, the second sub-substrate 12, and/or the third sub-substrate 13 containing the damaged electrodes and the first portion 21, the second portion 22, and/or the third portion (not shown) of the cover assembly 2 corresponding thereto can be replaced individually, thereby reducing maintenance costs.

In the present disclosure, other detail features of the detection device of FIG. 3B may be as those of FIG. 2A to FIG. 3A, which are not described again here.

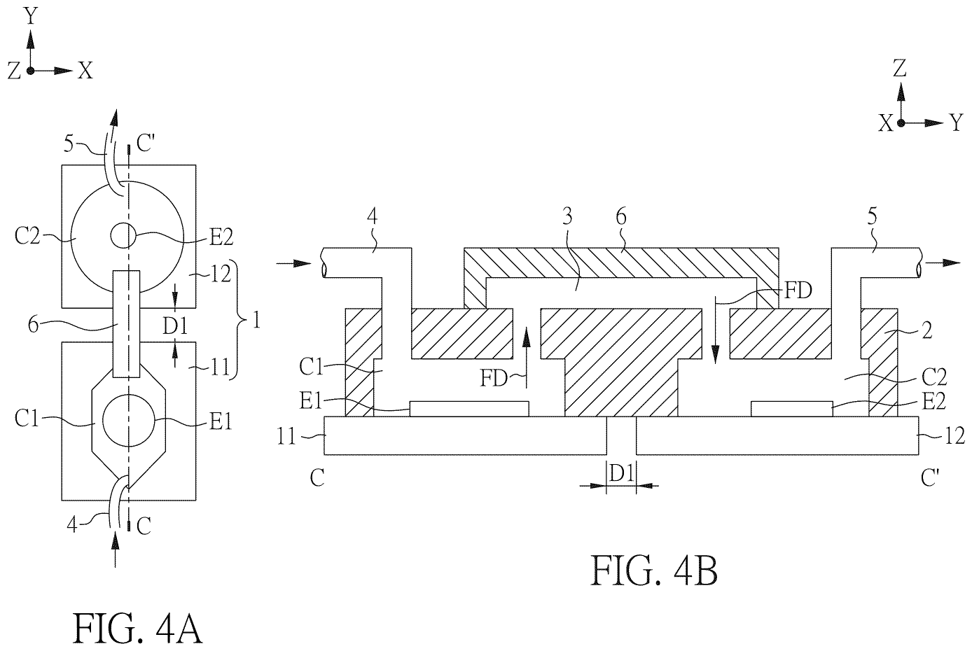

FIG. 4A is a top schematic view of a part of a detection device according to one embodiment of the present disclosure. FIG. 4B is a cross-sectional schematic view of a line C-C′ of FIG. 4A. The detection device of FIG. 4A is similar to that of FIG. 2A, except for the following differences. In addition, for the sake of convenience, the cover assembly 2 is omitted in FIG. 4A.

In one embodiment of the present disclosure, as shown in FIG. 4A and FIG. 4B, the detection device may further comprise another cover 6 disposed on the cover assembly 2, wherein the cover assembly 2 and the cover 6 together form the connecting pipe 3. The solution can flow into the first cavity C1 from the inflow pipe 4, and then flow to the second cavity C2 through the connecting pipe 3 formed by the cover assembly 2 and the cover 6, and finally flow out through the outflow pipe 5.

In one embodiment of the present disclosure, as shown in FIG. 4B, the cover assembly 2 and the first sub-substrate 11 may together form the first cavity C1, and the cover assembly 2 and the second sub-substrate 12 may together form the second cavity C2. Through the aforesaid design, the first electrode E1 and the second electrode E2 may be disposed on different sub-substrates, that is, the first electrode E1 is disposed on the first sub-substrate 11 and the second electrode E2 is disposed on the second sub-substrate 12. Thus, when one of the first electrode E1 or the second electrode E2 is damaged, the first sub-substrate 11 or the second sub-substrate 12 can be replaced independently, thereby reducing maintenance costs.

In the present disclosure, other detail features of the detection device of FIG. 4A and FIG. 4B may be as those of FIG. 2A and FIG. 2B, which are not described again here.

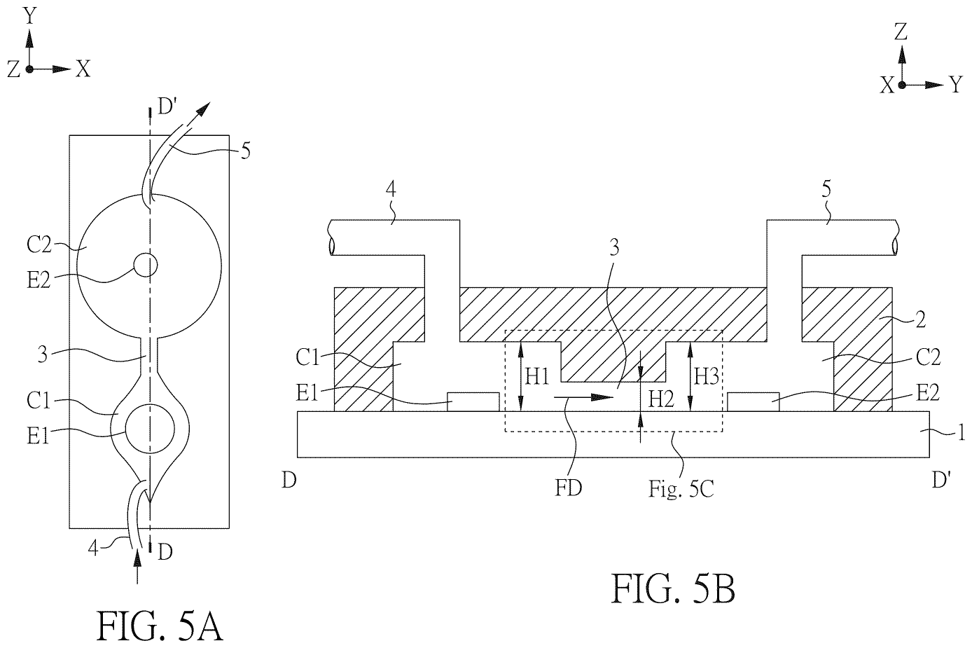

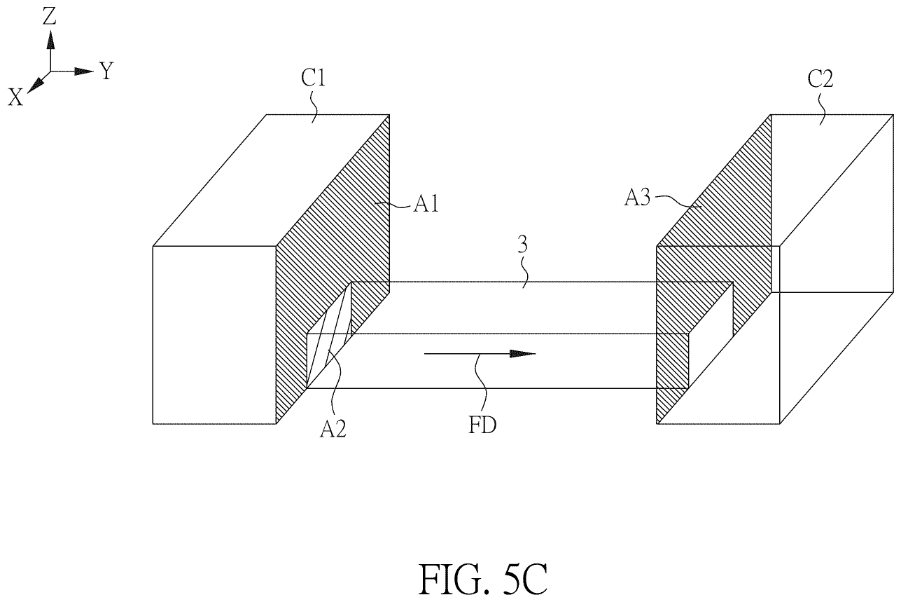

FIG. 5A is a top schematic view of a part of a detection device according to one embodiment of the present disclosure. FIG. 5B is a cross-sectional schematic view of a line D-D′ of FIG. 5A. FIG. 5C is a partial enlarged schematic view of FIG. 5B. The detection device of FIG. 5A is similar to that of FIG. 1A, except for the following differences. In addition, for the sake of convenience, the cover assembly 2 is omitted in FIG. 5A.

In one embodiment of the present disclosure, as shown in FIG. 5A and FIG. 5B, the cover assembly 2 and the substrate assembly 1 together form the connecting pipe 3. The solution may flow from the inflow pipe 4 into the first cavity C1, then flow through the connecting pipe 3 formed by the cover assembly 2 and the substrate assembly 1 to the second cavity C2, and finally flow out through the outflow pipe 5.

In one embodiment of the present disclosure, as shown in FIG. 5B, in a cross section, in the normal direction Z of the substrate assembly 1, the first cavity C1 has a first height H1, the connecting pipe 3 has a second height H2, and the first height H1 is greater than the second height H2. In one embodiment of the present disclosure, as shown in FIG. 5B, in a cross section, in the normal direction Z of the substrate assembly 1, the second cavity C2 has a third height H3, and the third height H3 is greater than the second height H2. In one embodiment of the present disclosure, the heights of the first cavity C1/the second cavity C2/the connecting pipe 3 refer to, for example, the minimum heights of the first cavity C1/the second cavity C2/the connecting pipe 3 in a direction perpendicular to the solution flow direction FD.

In one embodiment of the present disclosure, as shown in FIG. 5C, the first cavity C1 has a first cross-sectional area A1 and the connecting pipe 3 has a second cross-sectional area A2 in the normal direction Z of the substrate assembly 1, wherein the first cross-sectional area A1 is greater than the second cross-sectional area A2. In one embodiment of the present disclosure, as shown in FIG. 5C, in the normal direction Z of the substrate assembly 1, the second cavity C2 has a third cross-sectional area A3, and the third cross-sectional area A3 is greater than the second cross-sectional area A2. In one embodiment of the present disclosure, the cross-sectional areas of the first cavity C1/the second cavity C2/the connecting pipe 3 refer to, for example, the minimum cross-sectional areas of the first cavity C1/the second cavity C2/the connecting pipe 3 perpendicular to the solution flow direction FD.

In one embodiment of the present disclosure, in a cross section, as shown in FIG. 5A, the first cavity C1 may be irregular in shape, and the second cavity C2 may be circular in shape, but the present disclosure is not limited thereto. In addition, in the present disclosure, other detail features of the detection device shown in FIG. 5A and FIG. 5B may be as those of FIG. 1A and FIG. 1B, which are not described again here.

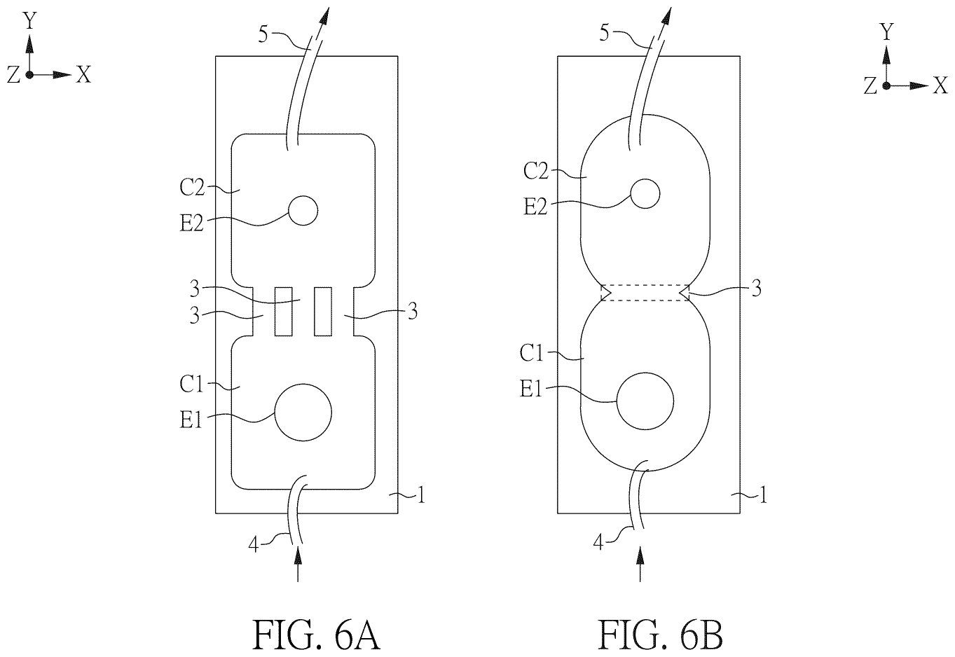

FIG. 6A is a top schematic view of a part of a detection device according to one embodiment of the present disclosure. The detection device of FIG. 6A is similar to that of FIG. 5A, except for the following differences. In addition, for the sake of convenience, the cover assembly 2 is omitted in FIG. 6A.

In one embodiment of the present disclosure, as shown in FIG. 6A, the detection device may comprise multiple connecting pipes 3 respectively connecting the first cavity C1 and the second cavity C2. The solution can flow from the first cavity C1 to the second cavity C2 through multiple connecting pipes 3. For example, FIG. 6A shows three connecting pipes 3 as an example. However, the present disclosure is not limited thereto, the number of connecting pipes 3 can be adjusted as needed, such as two, four or more. In the present disclosure, the cross section of FIG. 6A may be referred to that shown in FIG. 5B, that is, the second heights H2 of multiple connecting pipes 3 may be respectively less than the first height H1 of the first cavity C1 and less than the third height H3 of the second cavity C2. In the present disclosure, the cross section of FIG. 6A may be referred to those shown in FIG. 5B and FIG. 5C, that is, the second cross-sectional areas A2 of multiple connecting pipes 3 may be respectively less than the first cross-sectional area A1 of the first cavity C1 and less than the third cross-sectional area A3 of the second cavity C2.

In one embodiment of the present disclosure, in a cross section, as shown in FIG. 6A, the projection area of the first cavity C1 on the substrate assembly 1 may be approximately equal to the projection area of the second cavity C2 on the substrate assembly 1, but the present disclosure is not limited thereto. In one embodiment of the present disclosure, in a cross section, as shown in FIG. 6A, the first cavity C1 may be, for example, a rectangle with curved edges, and the second cavity C2 may be, for example, a rectangle with curved edges, but the present disclosure is not limited thereto. In addition, other detail features of the detection device of FIG. 6A may be as those of FIG. 5A and FIG. 5B, which are not described again here.

FIG. 6B is a top schematic view of a part of a detection device according to one embodiment of the present disclosure. The detection device of FIG. 6B is similar to that of FIG. 5A, except for the following differences. In addition, for the sake of convenience, the cover assembly 2 is omitted in FIG. 6B.

In one embodiment of the present disclosure, as shown in FIG. 6B, the first cavity C1 may be connected to the second cavity C2 through the connecting pipe 3. In one embodiment of the present disclosure, in a cross section, as shown in FIG. 6B, the projection area of the first cavity C1 on the substrate assembly 1 may be approximately equal to the projection area of the second cavity C2 on the substrate assembly 1, but the present disclosure is not limited thereto. In one embodiment of the present disclosure, in a cross section, as shown in FIG. 6B, the first cavity C1 may be, for example, elliptical, and the second cavity C2 may be, for example, elliptical, but the present disclosure is not limited thereto.

In the present disclosure, the cross section of FIG. 6B may be referred to that of FIG. 5B. That is, the second height H2 of the connecting pipe 3 may be less than the first height H1 of the first cavity C1 and less than the third height H3 of the second cavity C2. In the present disclosure, the cross section of FIG. 6B may be referred to those shown in FIG. 5B and FIG. 5C. That is, the second cross-sectional area A2 of the connecting pipe 3 may be less than the first cross-sectional area A1 of the first cavity C1 and less than the third cross-sectional area A3 of the second cavity C2. In addition, other detail features of the detection device of FIG. 6B may be as those of FIG. 5A and FIG. 5B, which are not described again here.

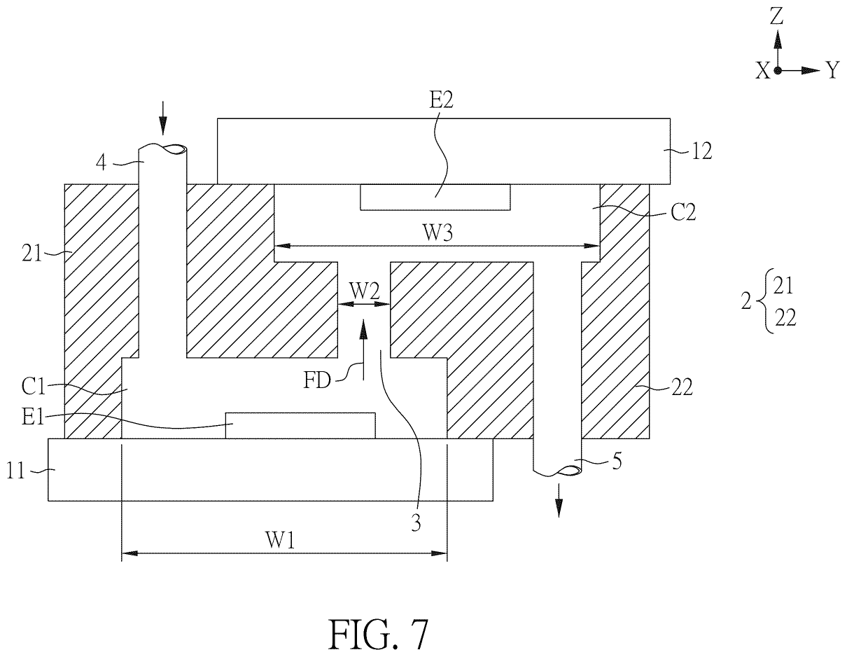

FIG. 7 is a cross-sectional schematic view is a part of a detection device according to one embodiment of the present disclosure. The detection device of FIG. 7 is similar to that of FIG. 1B, except for the following differences.

In one embodiment of the present disclosure, as shown in FIG. 7, the detection device may comprise: a first sub-substrate 11; a second sub-substrate 12 disposed opposite to the first sub-substrate 11; a cover assembly 2 disposed between the first sub-substrate 11 and the second sub-substrate 12, wherein the cover assembly 2 and the first sub-substrate 11 together form a first cavity C1, and the cover assembly 2 and the second sub-substrate 12 together form a second cavity C2; a first electrode E1 disposed in the first cavity C1; a second electrode E2 disposed in the second cavity C2; a connecting pipe 3 connecting the first cavity C1 and the second cavity C2; an inflow pipe 4 connecting the first cavity C1; and an outflow pipe 5 connecting the second cavity C2.

In one embodiment of the present disclosure, as shown in FIG. 7, the cover assembly 2 comprises a first portion 21 and a second portion 22, and the first portion 21 and the second portion 22 together form the connecting pipe 3. The solution flows from the inflow pipe 4 into the first cavity C1, through the connecting pipe 3 to the second cavity C2, and finally out through the outflow pipe 5. The solution forms a loop between the first electrode E1 and the second electrode E2, enabling solution testing.

In the present disclosure, the materials of the first sub-substrate 11 and the second sub-substrate 12 may be similar to that of the substrate assembly 1 (as shown in FIG. 1B), and the material of each components in the detection device of FIG. 7 may also be referred to those described above, which are not described again here. In addition, other detail features of the detection device of FIG. 7 may be as those shown in FIG. 1B and FIG. 1C, which are not described again here.

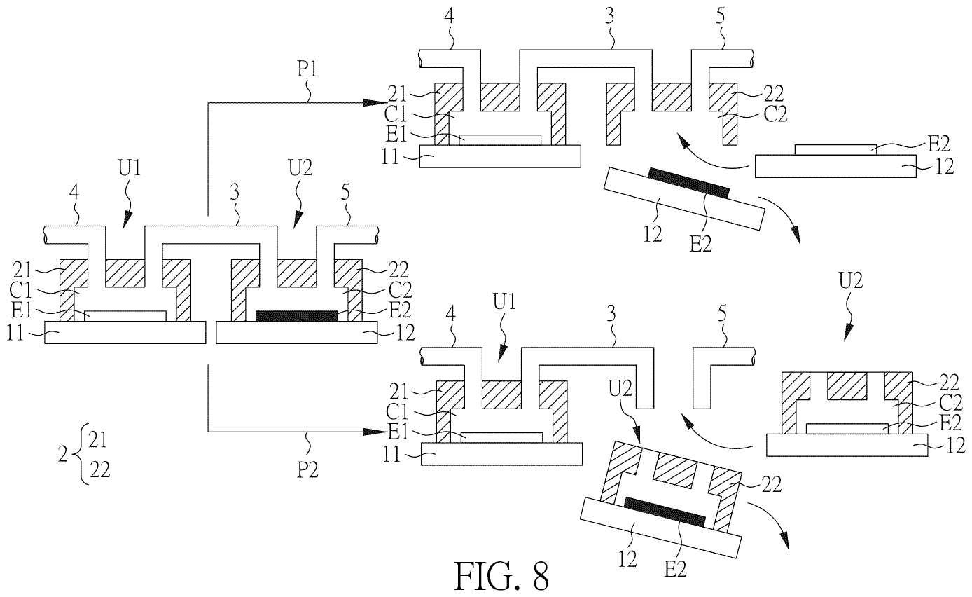

FIG. 8 is an operation schematic view according to one embodiment of the present disclosure. In FIG. 8, the black pattern represents the damaged electrode.

In one embodiment of the present disclosure, as shown in FIG. 8, the detection device may comprise a first unit U1 and a second unit U2, wherein the first unit U1 comprises the first sub-substrate 11, the first portion 21 of the cover assembly 2 and the first electrode E1 disposed on the first sub-substrate 11, and the first portion 21 of the cover assembly 2 and the first sub-substrate 11 together form the first cavity C1; the second unit U2 comprises the second sub-substrate 12, the second portion 22 of the cover assembly 2 and the second electrode E2 disposed on the second sub-substrate 12, and the second portion 22 of the cover assembly 2 and the second sub-substrate 12 together form the second cavity C2.

When one of the first electrode E1 or the second electrode E2 is damaged, the damaged first electrode E1 or the damaged second electrode E2 can be replaced separately. For example, the path P1 may be selected and only the first sub-substrate 11 or the second sub-substrate 12 is replaced. Alternatively, the path P2 may be selected and only the first unit U1 or the second unit U2 is replaced. Thus, the maintenance costs can be reduced. More specifically, as shown in FIG. 8, for example, when the second electrode E2 is damaged, the path P1 is selected, and the second sub-substrate 12 containing the damaged second electrode E2 can be replaced with another second sub-substrate 12 containing the new second electrode E2; or the path P2 is selected, and the second unit U2 containing the damaged second electrode E2 can be replaced with another second unit U2 containing the new second electrode E2. Thus, the detection device does not need to be scrapped entirely, which can extend its service life and reduce maintenance costs.

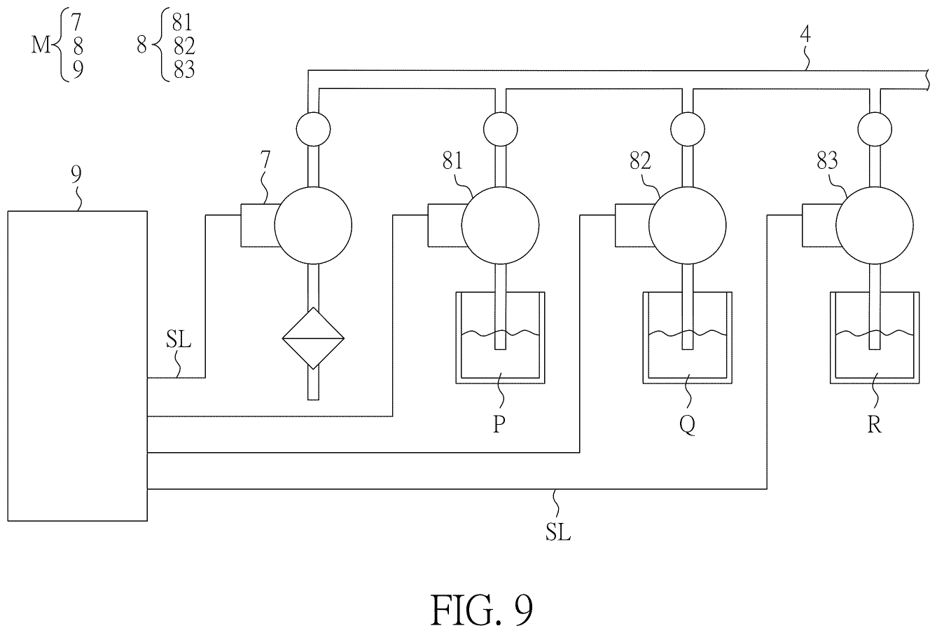

FIG. 9 is a schematic view of a delivery module according to one embodiment of the present disclosure.

In one embodiment of the present disclosure, as shown in FIG. 9, the detection device may further comprise a delivery module M connecting the inflow pipe 4 (any inflow pipe 4 shown in FIG. 1A to FIG. 7), and the delivery module M may be used to introduce a test solution into the inflow pipe 4 to detect the test solution. More specifically, the delivery module M may comprise a gas pump 7 and a liquid pump 8, and the gas pump 7 and the liquid pump 8 respectively connect the inflow pipe 4. The liquid pump 8 may deliver the test solution to the inflow pipe 4. The gas pump 7 may blow out the test solution remaining in the inflow pipe 4 for the next test.

In one embodiment of the present disclosure, as shown in FIG. 9, the delivery module M may comprise multiple liquid pumps 81, 82, 83 respectively connecting the inflow pipe 4, the liquid pumps 81, 82, 83 may be used to provide different test solutions (for example, test solutions P, Q, R) into the inflow pipe 4 respectively to perform the detections of different test solutions. More specifically, during the testing process, the liquid pump 81 may supply the test solution P to the inflow pipe 4 for testing. After testing is complete, the gas pump 7 may remove any remaining test solution P in the inflow pipe 4. Next, the liquid pump 82 may supply the test solution Q to the inflow pipe 4. After testing is complete, the gas pump 7 may remove any remaining test solution Q in the inflow pipe 4, facilitating subsequent detection of the test solution R.

In one embodiment of the present disclosure, as shown in FIG. 9, the delivery module M may further comprise a controller 9, which may be electrically connected to the gas pump 7 and the liquid pump 8 through signal lines SL respectively, to automatically control the movements of the gas pump 7 and the liquid pump 8.

In the present disclosure, by disposing the first electrode E1 and the second electrode E2 in different cavities, damage to the first electrode E1 and/or the second electrode E2 can be reduced, thereby extending the life of the detection device or improving detection accuracy. In addition, through the design of the present disclosure, the damaged first electrode E1 or second electrode E2 can be replaced separately, thereby reducing maintenance costs.

The above specific embodiments should be construed as merely illustrative and not limitative of the remainder of the disclosure in any way.

1. An detection device, comprising:
a substrate assembly;
a cover assembly disposed on the substrate assembly, wherein the substrate assembly and the cover assembly together form a first cavity and a second cavity;
a first electrode disposed in the first cavity;
a second electrode disposed in the second cavity;
a connecting pipe connecting the first cavity and the second cavity;
an inflow pipe connecting the first cavity and the second cavity; and
an outflow pipe connecting the first cavity or the second cavity.

2. The detection device of claim 1, wherein the cover assembly comprises a first portion and a second portion, the first portion and the substrate assembly together form the first cavity, and the second portion and the substrate assembly together form the second cavity.

3. The detection device of claim 2, wherein the first portion is separated from the second portion by a distance.

4. The detection device of claim 1, wherein the substrate assembly comprises a first sub-substrate and a second sub-substrate, and the first sub-substrate is separated from the second sub-substrate by a distance, wherein the first sub-substrate and the cover assembly together form the first cavity, and the second sub-substrate and the cover assembly together form the second cavity.

5. The detection device of claim 1, wherein the cover assembly comprises a first portion and a second portion, and the substrate assembly comprises a first sub-substrate and a second sub-substrate, wherein the first portion and the first sub-substrate together form the first cavity, and the second portion and the second sub-substrate together form the second cavity.

6. The detection device of claim 5 wherein the first portion is separated from the second portion by a distance, and the first sub-substrate is separated from the second sub-substrate by another distance.

7. The detection device of claim 1, further comprising another cover disposed on the cover assembly, wherein the cover assembly and the cover together form the connecting pipe.

8. The detection device of claim 1, wherein in a cross section, the first cavity has a first width and the connecting pipe has a second width in a direction perpendicular to a normal direction of the substrate assembly, wherein the first width is greater than the second width.

9. The detection device of claim 8, wherein in the cross section, the second cavity has a third width in the direction perpendicular to the normal direction of the substrate assembly, and the third width is greater than the second width.

10. The detection device of claim 1, wherein the first cavity has a first cross-sectional area and the connecting pipe has a second cross-sectional area perpendicular a normal direction of the substrate assembly, wherein the first cross-sectional area is greater than the second cross-sectional area.

11. The detection device of claim 10, wherein the second cavity has a third cross-sectional area perpendicular to the normal direction of the substrate assembly, and the third cross-sectional area is greater than the second cross-sectional area.

12. The detection device of claim 1, wherein the cover assembly and the substrate assembly together form the connecting pipe.

13. The detection device of claim 1, wherein in a cross section, the first cavity has a first height and the connecting pipe has a second height in a normal direction of the substrate assembly, wherein the first height is greater than the second height.

14. The detection device of claim 13, wherein the second cavity has a third height in the normal direction of the substrate assembly, and the third height is greater than the second height.

15. The detection device of claim 1, wherein the first electrode is a working electrode, and the second electrode is a reference electrode.

16. The detection device of claim 15, wherein reference electrode comprises silver chloride.

17. The detection device of claim 1, wherein the inflow pipe connects the first cavity, and the outflow pipe connects the second cavity.

18. The detection device of claim 1, wherein the inflow pipe connects the first cavity, and the outflow pipe connects the first cavity.

19. The detection device of claim 1, further comprising a delivery module connecting the inflow pipe, wherein the delivery module is used to input a test solution into the inflow pipe.

20. The detection device of claim 18, wherein the delivery module further comprises a gas pump and a liquid pump, and the gas pump and the liquid pump respectively connect the inflow pipe.
